(19) United States
(12) Patent Application Publication
(10) Pub. No.: US 2026/0030090 A1
(43) Pub. Date: Jan. 29, 2026

(54) SUBSTRATE DEFECT ANALYSIS BASED ON MULTIPLE DATA TYPES

(71) Applicant: Applied Materials, Inc., Santa Clara, CA (US)

(72) Inventors: Bhaskar Kumar, San Jose, CA (US); Qinyi Chen, San Jose, CA (US); Deenesh Padhi, Sunnyvale, CA (US); Hexuan Wang, Fremont, CA (US); Abhinav Kumar, Milpitas, CA (US)

(21) Appl. No.: 18/783,230

(22) Filed: Jul. 24, 2024

(51) Int. Cl. G06F 11/07

(52) U.S. Cl. CPC G06F 11/0793; G06F 11/0721; G06F 11/079

(57) ABSTRACT

A method includes obtaining defect data and context data in association with a substrate, and providing the defect data and the context data to a first trained machine learning model as input. The method further includes obtaining output from the first trained machine learning model based on the defect data and the context data. The output is indicative of a predicted root cause in association with the defect data. The method further includes performing a corrective action in view of the output.

### TECHNICAL FIELD

The present disclosure relates to methods associated with substrate defect analysis procedures. Specifically, the present disclosure relates to methods associated with substrate defect analysis, based on multiple types of input data.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. In some cases, products are produces that have defects. Minimizing defects or correcting defect root causes improves manufacturing reliability. Machine learning models are used in various process control and predictive functions associated with manufacturing equipment. Machine learning models are trained using data associated with the manufacturing equipment. Images of products (e.g., manufactured devices) may be taken, which may enhance understanding of device function, failure, performance, may be used for metrology or inspection, or the like.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method includes obtaining, by a processing device, defect data in association with a substrate. The method further includes obtaining context data in association with the substrate. The method further includes providing the defect data and the context data to a trained machine learning model. The method further includes obtaining output from the trained machine learning model, based on the defect data and the context data. The output is indicative of a predicted root cause in association with the defect data. The method further includes performing a corrective action in view of the output.

In another aspect of the present disclosure, a non-transitory machine-readable storage medium stores instructions which, when executed by a processing device, cause the device to perform operations including obtaining defect data in association with a substrate. The operations further include obtaining context data in association with the substrate. The operations further include providing the defect data and the context data to a trained machine learning model. The operations further include obtaining output from the trained machine learning model, based on the defect data and the context data. The output is indicative of a predicted root cause in association with the defect data. The operations further include performing a corrective action in view of the output.

In another aspect of the present disclosure, a system includes memory and a processing device coupled to the memory. The processing device is configured to obtain defect data and context data in association with a substrate. The processing device is further configured to provide the defect data and the context data to a trained machine learning model. The processing device is further configured to obtain output from the trained machine learning model, based on the defect data and the context data. The output is indicative of a predicted root cause in association with the defect data. The processing device is further configured to perform a corrective action in view of the output.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2 depicts a block diagram of a system including an example data set generator for creating data sets for one or more supervised models, according to some embodiments.

FIG. 3 is a block diagram illustrating a system for generating output data, according to some embodiments.

FIG. 4A is a flow diagram of a method for generating a data set for a machine learning model, according to some embodiments.

FIG. 4B is a flow diagram of a method for generating and utilizing predicted root cause data, according to some embodiments.

FIG. 5A depicts a data flow in association with operation of a defect analysis system, according to some embodiments.

FIG. 5B depicts an example graphical defect analysis wafer signature output, according to some embodiments.

FIG. 6 is a block diagram illustrating a computer system, according to some embodiments.

### DETAILED DESCRIPTION

Described herein are technologies related to a method of defect analysis in substrate manufacturing systems. Manufacturing equipment is used to produce products, such as substrates (e.g., wafers, semiconductors). Manufacturing equipment may include a manufacturing or processing chamber to separate the substrate from the environment. The properties of produced substrates are to meet target values to facilitate specific functionalities. Manufacturing parameters are selected to produce substrates that meet the target property values. Many manufacturing parameters (e.g., hardware parameters, process parameters, etc.) contribute to the properties of processed substrates. Manufacturing systems may control parameters by specifying a set point for a property value and receiving data from sensors disposed within the manufacturing chamber, and making adjustments to the manufacturing equipment until the sensor readings match the set point. In some embodiments, one or more substrates processed by the manufacturing equipment may include defects. Correcting root causes of defects may be a source of significant effort and expense at a manufacturing facility.

A variety of root causes may be related to defects of a substrate. In some cases, a defect may be caused by a combination of factors, or multiple causes may be potentially related to a single type of defect. In other cases, a single root cause may be associated with multiple defect modes, multiple types of defects, or the like.

A variety of data types, data sources, data signatures, and the like may be indicative of a root cause of one or more defects, a defect generation mode, or the like. Data describing one or more defects of a substrate may diagnostic of defect root causes. Contextual data, which includes hardware data, recipe data, etc., may further be used in determining root causes. Data indicative of hardware (e.g., of one or more components of the manufacturing equipment) may be diagnostic of defect root causes. Recipe data may be diagnostic of defect root causes.

Data describing defects may include multiple data types or sources. Defect images may be used to classify defects and perform root cause analysis. Various features of defects may be discerned based on defect images. For example, defect size, defect shape, defect texture, defect regularity, along with many other defect features may be determined based on one or more defect images. Each of these features extracted from one or more defect images of the defect may indicate one or more potential root causes for defect formation. Defect height may be measured and utilized in determining root causes. Defect composition may be measured and utilized in determining root causes. Defect classification, defect location, and defect spatial signature may additionally be utilized in determining root causes.

Contextual data, e.g., data contributing to a defect but not a result of measurement of the defect, may be used for determining or predicting defect root causes. Data indicative of hardware, used to determine or predict defect root causes, may include identifying data, such as data identifying manufacturing facilities, tools, chambers, or the like. Hardware data may further include indications of components included in manufacturing equipment, such as identifiers of component models, component manufacturing batches, or the like. Process data may also be used in determining defect root causes. Process data may include recipe data. Process data may include seasoning data, e.g., data indicative of various materials, coatings, or the like present in a process chamber. Process data may include chemistry data, e.g., indications of interactions between process gases, substrate material, coating material, chamber wall or other component material, plasma byproducts, deposition or etch byproducts, or other materials that may induce relevant chemistry in the process chamber.

In some systems, integration of these various data modalities in root cause prediction may be expensive, time-consuming, inconvenient, unreliable, overly dependent on subject matter expertise, or impossible. Determining defect root causes may involve an analysis of many data types. Different data types in association with the same defect or set of defects may indicate different potential defect root causes. Efficient analysis may include weighing conflicting information from different data sources, including defect data and contextual information. Subject matter experts may provide guidance toward one or more potential defect modes from those indicated by the data in association with the defects, but the expertise of a user may be limited to a process type, chamber type, tool, type, substrate design, defect type, or otherwise limited. Ensuring sufficient subject matter expertise for all potential combinations of manufacturing equipment, materials, processes, substrates, defects, and the like may constitute a significant investment. Predicting defect root causes from varied data sources without subject matter expertise may delay diagnosis of defect root causes, may cause delays in correcting defect root causes, may cause extended chamber down time, may cause premature maintenance, cleaning, seasoning, or component replacement of manufacturing equipment, etc.

Determining whether an action has resolved a defect can also be costly. For example, with a defect root cause in place, a defect may still be a rare occurrence. Multiple substrates may be manufactured to determine whether an action has improved a rate of occurrence of one or more types of defects. Performing a maintenance action may include performing process chamber maintenance, which may include operations of chamber cleaning, seasoning, and validation, which may be repeated after processing several substrates if it is determined that the corrective action did not address a root cause associated with one or more target defects.

Further, performing operations to validate a root cause correction, in particular repeatedly in the case where multiple iterations of root cause correction are performed, may be a significant cause of expense. Testing or validating of manufacturing equipment maintenance may incur costs in terms of technician time, chamber down time, process material cost, substrate material cost, costs associated with defect measurement of test substrates, costs associated with disposing of test substrates, energy costs, environmental impact, and the like. Any advantage in reducing time, effort, or number of possibilities while determining or predicting a defect root cause may be highly valuable for a manufacturing facility.

Aspects of the present disclosure may address one or more shortcomings of conventional methods. In some embodiments of the present disclosure, a self-driving defect machine is disclosed. The self-driving defect may comprise a defect analysis system. The designation “self-driving” may be indicative of a level of user input involved in defect analysis, e.g., the defect analysis system may proceed substantially without user input, from data harvesting to output generation and corrective action performance.

In some embodiments, a collection of models, algorithms, analysis techniques, and the like may be combined in the defect analysis system. Analysis may be performed based on data harvested from multiple sources and associated with multiple data modalities, including defect data, contextual data, and the like. In some embodiments, defect data may include defect image data, such as a number of defect features extracted from one or more images of the defect. Defect data may include further defect feature data, such as defect height data. Defect data may further include defect composition data. Defect data may further include spatial defect signature data, e.g., a signature of a distribution of defect locations across a substrate. Defect data may further include defect classification data.

Context data may be included in data provided to the defect analysis system. Context data may include identifying data of a process chamber, such as a chamber identification, tool identification, manufacturing facility identification, or the like. Context data may include identifying data of hardware components, such as an indication of included hardware components, component age, component health, etc. Context data may include process data, such as process recipe data, including process gas data, process temperature data, process plasma properties, or the like. Context data may include seasoning data, e.g., chamber condition data, chamber coating data, chamber maintenance history data, or the like. Context data may include chemistry data, e.g., data indicative of materials of the chamber, materials introduced in a process, process byproduct chemistry, substrate material chemistry, and the like.

Various analysis modules may be used together in generation of features associated with the data channels for use by the defect analysis system. For example, data may be harvested (e.g., from one or more data stores, from one or more defect measurement tools, or the like), provided to an appropriate analysis tool, and features may be extracted for use by the defect analysis system. The analysis tools may include models, including machine learning models, physics-based models, statistical models, rule-based or heuristic models, or the like. For example, a defect image may be provided to one or more trained machine learning models configured to extract image features from the defect image. In some embodiments, one or more parameters may be defined to determine use of various features output by defect data channels. For example, a defect image feature extraction model may output a large number of image features, only a subset of which may be substantially tied to defect root cause analysis. One or more parameters may be used to determine which features output by a feature extraction model are to be provided for defect root cause analysis. Algorithmic modeling techniques may be used to provide features based on other data modes, such as defect height, defect composition, defect spatial signature, defect classifications, etc. For example, defect composition measurements may include artifacts that may be excluded based on a rule-based or statistical model, spatial signatures of defects may be classified by a trained machine learning model, etc.

Features of interest from defect data channels and features of interest from context data channels may be combined to generate output of a defect analysis system. In some embodiments, features of defect data and features of contextual data may be provided to a trained machine learning model for generating defect analysis output. Feature inputs may be weighted, e.g., to align relative importance of input features. For example, a chamber identification may include a single data point, while defect data features extracted from a defect image may include hundreds of features. Input to a defect analysis machine learning model may be weighted to overcome differences in a number of provided features related to data input sources.

In some embodiments, a library of trained machine learning models may be used for a defect analysis system. In some embodiments, a trained machine learning model may include an input indicative of conditions of the input data that may in other embodiments may be associated with a selection of trained machine learning model, e.g., a universal model or a combination of models may be used in combining defect data and context data. In some embodiments, e.g., based on reliability or availability of input data from various input data sources, different models or different model parameters may be selectable for defect analysis, root cause analysis, etc. Based on available input data, a model may be selected from a library of models for defect analysis.

In some embodiments, selecting a trained machine learning model for incorporating defect data and context data for defect analysis may be based on availability or reliability of input data of various types. Some types of data associated with defects may be correlated. For example, defect composition data may be connected to chemistry context data, defect spatial signature data may be connected to hardware component data, etc. A trained machine learning model may be selected to offset missing or unreliable data. For example, additional weight may be placed on defect composition data in a case when chamber chemistry data is unavailable.

Output of a defect analysis model may include root cause predictions. Output of a defect analysis model may include a defect correction partition plan. Output of a defect analysis model may include one or more display functions, such as a substrate map to root cause overlay, overlay of hardware components related to substrate defects, etc.

Root cause predictions may include a number of potential root causes related to input data (e.g., related to model input). Root cause predictions may include indications of confidence in various potential root causes. Root cause predictions may include potential solutions, e.g., recommended maintenance, recommended cleaning, recommended hardware component replacement, or the like. In some embodiments, a defect analysis system may enact one or more corrective actions, such as providing an alert to a user, initiating seasoning operations, initiating cleaning operations, scheduling maintenance or replacement of components, or the like.

A partition plan may be generated by the defect analysis system, e.g., by a trained machine learning model. The partition plan may be or include recommend or suggested operations, testing procedures, or the like for diagnosing and/or correcting root causes in association with the manufacturing equipment. The partition plan may include an indication of a suggested order to perform various actions for root cause diagnosis and/or correction. A partition plan may assist with determining relevant hardware components, chemistry, or the like.

In some embodiments, a defect analysis system may incorporate user input, e.g., expert feedback. For example, a user may provide feedback based on following a partition plan, which may be used to perform retraining of one or more models associated with generating the partition plan.

Aspects of the present disclosure provide technological improvements over conventional methods. By providing contextual data and defect data to a defect analysis system, obtaining output from the defect analysis system, and performing one or more actions based on the output, costs associated with defect analysis may be reduced. Reduction of costs may include reductions in defect correction experimentation, e.g., fewer incorrect actions may be taken in an attempt to correct the root cause of one or more substrate defects. Reduction of costs may include reductions in defect reduction validation, e.g., a reduction in a number of tests associated in determining whether a root cause of defect generation was addressed. Reduction of costs associated with validation may include reduction of process materials, substrate materials, process time, energy, technician time, environmental impact, metrology processes, etc., in association with determining whether a defect root cause has been addressed. Reduction of costs may include reduction in time expended in correcting defect root causes, e.g., in association with improved root cause prediction, partition plan generation, etc. Reducing time expended in correcting defect root causes may increase process chamber up-time, reduce process chamber down-time, reduce unnecessary or unhelpful maintenance actions, reduce costs associated with cleaning or seasoning materials, reduce costs associated with premature replacement of components of the process chamber, etc.

In one aspect of the present disclosure, a method includes obtaining, by a processing device, defect data in association with a substrate. The method further includes obtaining context data in association with the substrate. The method further includes providing the defect data and the context data to a trained machine learning model. The method further includes obtaining output from the trained machine learning model, based on the defect data and the context data. The output is indicative of a predicted root cause in association with the defect data. The method further includes performing a corrective action in view of the output.

In another aspect of the present disclosure, a non-transitory machine-readable storage medium stores instructions which, when executed by a processing device, cause the device to perform operations including obtaining defect data in association with a substrate. The operations further include obtaining context data in association with the substrate. The operations further include providing the defect data and the context data to a trained machine learning model. The operations further include obtaining output from the trained machine learning model, based on the defect data and the context data. The output is indicative of a predicted root cause in association with the defect data. The operations further include performing a corrective action in view of the output.

In another aspect of the present disclosure, a system includes memory and a processing device coupled to the memory. The processing device is configured to obtain defect data and context data in association with a substrate. The processing device is further configured to provide the defect data and the context data to a trained machine learning model. The processing device is further configured to obtain output from the trained machine learning model, based on the defect data and the context data. The output is indicative of a predicted root cause in association with the defect data. The processing device is further configured to perform a corrective action in view of the output.

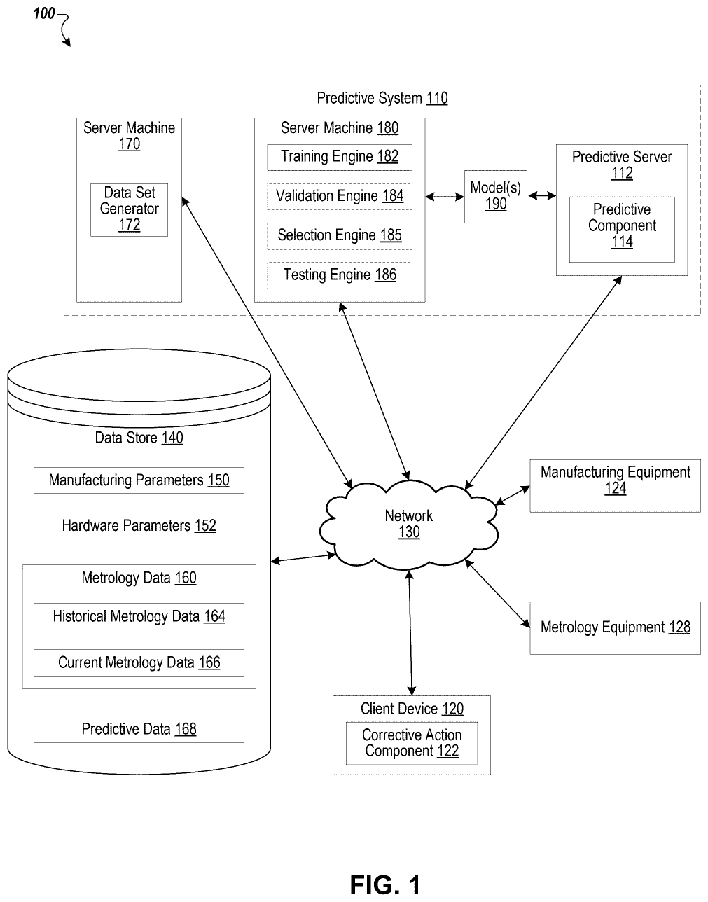

FIG. 1 is a block diagram illustrating an exemplary system 100 (exemplary system architecture), according to some embodiments. The system 100 includes a client device 120, manufacturing equipment 124, metrology equipment 128, predictive server 112, and data store 140. The predictive server 112 may be part of predictive system 110. Predictive system 110 may further include server machines 170 and 180.

Manufacturing equipment 124 may be or include a combination of hardware components for performing substrate processing operations. Manufacturing equipment 124 may include one or more process chambers, which may be designed and/or configured to perform various processing operation, e.g., etch operations, deposition operations, anneal operations, etc. Manufacturing equipment 124 may include one or more tools, e.g., mainframes including a number of process chambers for providing processing environments for multiple substrates, for performing different process operations, or the like. Manufacturing equipment 124 may include one or more manufacturing facilities, e.g., including a number of process tools or process chambers for manufacturing substrates (such as semiconductor wafers).

Manufactured substrates may be processed for a target use or application. Manufactured substrates may exhibit properties dependent upon processing procedures and process conditions used in manufacturing the substrates. Substrates may have property values (film thickness, film strain, feature size, image data, defect data, etc.) measured by metrology equipment 128, e.g., measured at a standalone metrology facility. Metrology data 160 measured by metrology equipment 128 may be a component of data store 140. Metrology data 160 may include historical metrology data 164 (e.g., metrology data associated with previously processed products), and current metrology data 166 (e.g., data associated with one or more substrates of interest). Metrology data 160 may include measurements made by metrology equipment 128, analysis performed on the measurement data, output of one or more models associated with metrology equipment, or the like. For example, metrology data 160 may include images of defects, as well as measurements of the imaged defects extracted algorithmically from the images, as well as one or more image features extracted by a trained machine learning model from the defect images. Similarly, spectral data of a defect, along with data generated by analyzing the spectral data indicative of atomic composition of the defect, may be included in metrology data 160. Data measuring locations of a number of defects, as well as a classification of a general pattern of the defects, may be included in metrology data 160. Measurements of a defect, as well as a defect classification (e.g., generated by a trained machine learning model) may be included in metrology data 160.

In some embodiments, metrology data 160 may be provided without use of a standalone metrology facility, e.g., in-situ metrology data (e.g., metrology or a proxy for metrology collected during processing), integrated metrology data (e.g., metrology or a proxy for metrology collected while a product is within a chamber or under vacuum, but not during processing operations), inline metrology data (e.g., data collected after a substrate is removed from vacuum), etc. Metrology data 160 may include current metrology data 166 (e.g., metrology data associated with a product currently or recently processed).

Data store 140 may include manufacturing parameters 150. Manufacturing parameters 150 may include indications of process conditions utilized in processing one or more substrates. Manufacturing parameters 150 may include data indicative of process recipes. Manufacturing parameters 150 may include property set points, utilized by manufacturing equipment 124 in managing process conditions in association with processing one or more substrates Data store 140 may further include hardware parameters 152. Hardware parameters 152 may include data indicative of installed components of manufacturing equipment 124, history of manufacturing equipment 124, performance of manufacturing equipment 124, or the like. For example, identification of process chambers, tools, or facilities may be included in hardware parameters 152. Indications of chamber maintenance history, chamber seasoning or coating history or conditions, chamber materials and chemistry, or the like may be included in hardware parameters 152.

In some embodiments, metrology data 160, hardware parameters 152, or manufacturing parameters 150 may be processed (e.g., by the client device 120 and/or by the predictive server 112). Processing of the input data may include generating features. In some embodiments, the features are a pattern in the hardware parameters 152, metrology data 160, and/or manufacturing parameters 150 (e.g., slope, width, height, peak, etc.) or a combination of values from the hardware parameters, metrology data, and/or manufacturing parameters (e.g., power derived from voltage and current, etc.). The input data for processing may include features and the features may be used by predictive component 114 for performing signal processing and/or for obtaining predictive data 168 for performance of a corrective action.

Each instance (e.g., set) of metrology data 160 may correspond to a product (e.g., a substrate), a set of manufacturing equipment, a type of substrate produced by manufacturing equipment, or the like. Each instance of hardware parameters 152 and manufacturing parameters 150 may likewise correspond to a product, a set of manufacturing equipment, a type of substrate produced by manufacturing equipment, or the like. The data store may further store information associating sets of different data types, e.g. information indicative that a set of sensor data, a set of metrology data, and a set of manufacturing parameters are all associated with the same product, manufacturing equipment, type of substrate, etc.

In some embodiments, predictive system 110 may generate predictive data 168 using supervised machine learning (e.g., predictive data 168 includes output from a machine learning model that was trained using labeled data, such as sensor data labeled with metrology data (e.g., which may include synthetic microscopy images generated according to embodiments herein, etc.). In some embodiments, predictive system 110 may generate predictive data 168 using unsupervised machine learning (e.g., predictive data 168 includes output from a machine learning model that was trained using unlabeled data, output may include clustering results, principle component analysis, anomaly detection, etc.). In some embodiments, predictive system 110 may generate predictive data 168 using semi-supervised learning (e.g., training data may include a mix of labeled and unlabeled data, etc.).

Client device 120, manufacturing equipment 124, sensors 126, metrology equipment 128, predictive server 112, data store 140, server machine 170, and server machine 180 may be coupled to each other via network 130 for generating predictive data 168 to perform corrective actions. In some embodiments, network 130 may provide access to cloud-based services. Operations performed by client device 120, predictive system 110, data store 140, etc., may be performed by virtual cloud-based devices.

In some embodiments, network 130 is a public network that provides client device 120 with access to the predictive server 112, data store 140, and other publicly available computing devices. In some embodiments, network 130 is a private network that provides client device 120 access to manufacturing equipment 124, sensors 126, metrology equipment 128, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. Client device 120 may include a corrective action component 122. Corrective action component 122 may receive user input (e.g., via a Graphical User Interface (GUI) displayed via the client device 120) of an indication associated with manufacturing equipment 124. In some embodiments, corrective action component 122 transmits the indication to the predictive system 110, receives output (e.g., predictive data 168) from the predictive system 110, determines a corrective action based on the output, and causes the corrective action to be implemented. In some embodiments, corrective action component 122 obtains data associated with manufacturing equipment 124 (e.g., from data store 140, etc.) and the data associated with the manufacturing equipment 124 to predictive system 110.

In some embodiments, corrective action component 122 receives an indication of a corrective action from the predictive system 110 and causes the corrective action to be implemented. Each client device 120 may include an operating system that allows users to one or more of generate, view, or edit data (e.g., indication associated with manufacturing equipment 124, corrective actions associated with manufacturing equipment 124, etc.). A client device 120 may provide opportunity for providing alerts to one or more users, e.g., via a user interface (such as a graphical user interface). Client device 120 may be used by a user to provide information or instructions to system 100, e.g., a user may provide feedback on the accuracy of predictive data 168, which may then be incorporated into system 100 by updating parameters of one or more models 190, adjusting operations of predictive component 114 to improve performance or accuracy, or the like.

In some embodiments, metrology data 160 (e.g., historical metrology data 164) corresponds to historical property data of products (e.g., products processed using manufacturing parameters associated with historical hardware parameters 152 and historical manufacturing parameters of manufacturing parameters 150) and predictive data 168 is associated with predicted root causes of substrate defects. In some embodiments, predictive data 168 is or includes an indication of any abnormalities (e.g., abnormal products, abnormal components, abnormal manufacturing equipment 124, abnormal energy usage, etc.) and optionally one or more causes of the abnormalities. In some embodiments, predictive data 168 is an indication of change over time or drift in some component of manufacturing equipment 124, sensors 126, metrology equipment 128, and the like. In some embodiments, predictive data 168 is an indication of an end of life of a component of manufacturing equipment 124, sensors 126, metrology equipment 128, or the like. In some embodiments, predictive data 168 is an indication of a recommended plan for addressing defect root causes of manufacturing equipment 124, e.g., a partition plan.

Performing manufacturing processes that result in defective products can be costly in time, energy, products, components, manufacturing equipment 124, the cost of identifying the defects and discarding the defective product, etc. By inputting sensor data 142 (e.g., manufacturing parameters that are being used or are to be used to manufacture a product) into predictive system 110, receiving output of predictive data 168, and performing a corrective action based on the predictive data 168, system 100 can have the technical advantage of avoiding the cost of producing, identifying, and discarding defective products.

Manufacturing parameters may be suboptimal for producing product which may have costly results of increased resource (e.g., energy, coolant, gases, etc.) consumption, increased amount of time to produce the products, increased component failure, increased amounts of defective products, etc. By inputting data associated with substrate defects (e.g., manufacturing parameters 150, hardware parameters 152, metrology data 160, etc.) to an analysis module, a corrective action of updating manufacturing parameters (e.g., setting optimal manufacturing parameters), system 100 can have the technical advantage of using optimal manufacturing parameters (e.g., hardware parameters, process parameters, optimal design) to avoid costly results of suboptimal manufacturing parameters, such as reducing a rate of defect occurrence.

Corrective actions may be associated with one or more of preventative operative maintenance, corrective maintenance, design optimization, updating of manufacturing parameters, updating manufacturing recipes, feedback control, machine learning modification (e.g., updating one or more parameters of a trained machine learning model), or the like.

Hardware parameters 152 may include information indicative of which components are installed in manufacturing equipment 124, indicative of component replacements, indicative of component age, indicative of software version or updates, etc. Manufacturing parameters 150 may include process parameters such as temperature, pressure, flow, rate, electrical current, voltage, gas flow, lift speed, etc. In some embodiments, the corrective action includes causing preventative operative maintenance (e.g., replace, process, clean, etc. components of the manufacturing equipment 124). In some embodiments, the corrective action includes causing design optimization (e.g., updating manufacturing parameters, manufacturing processes, manufacturing equipment 124, etc. for an optimized product). In some embodiments, the corrective action includes a updating a recipe (e.g., altering the timing of manufacturing subsystems entering an idle or active mode, altering set points of various property values, etc.).

Predictive server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of predictive server 112, server machine 170, server machine 180, data store 140, etc., may be performed by a cloud computing service, cloud data storage service, etc.

Predictive server 112 may include a predictive component 114. In some embodiments, the predictive component 114 may receive data of interest (e.g., manufacturing parameters 150, hardware parameters 152, current metrology data 166, etc.), and generate output (e.g., predictive data 168) for performing corrective action associated with the manufacturing equipment 124 based on the current data. In some embodiments, predictive data 168 may include predicted defect root causes, in connection with one or more defects represented in current metrology data 166.

Manufacturing equipment 124 may be associated with one or more machine leaning models, e.g., model 190. Machine learning models associated with manufacturing equipment 124 may perform many tasks, including process control, classification, performance predictions, etc. Model 190 may be trained using data associated with manufacturing equipment 124 or products processed by manufacturing equipment 124, e.g., manufacturing parameters 150 (e.g., associated with process control of manufacturing equipment 124), hardware parameters 152, metrology data 160 (e.g., generated by metrology equipment 128), etc.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels associated with an image of a substrate including one or more defect; the first representational layer may abstract the pixels and encode edges; the second layer may compose and encode arrangements of edges; the third layer may encode higher level shapes (e.g., substrate defects, substrate defect shapes, etc.); and the fourth layer may perform a classification role, such as determining a type of defect in an image. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, predictive component 114 receives hardware parameters 152, current metrology data 166 and/or current manufacturing parameters 150, performs signal processing to break down the current data into sets of current data, provides the sets of current data as input to a trained model 190, and obtains outputs indicative of predictive data 168 from the trained model 190. In some embodiments, predictive component 114 may receive data indicative of one or more substrate defects (e.g., metrology data) and data indicative of context related to generation of those defects (e.g., associated hardware and manufacturing process parameters) and generate predictive defect root cause data in view of the input defect and context data. In some embodiments, predictive system 110 may include a large number of models, each configured to perform different tasks. In some embodiments, one or more models may be configured to generate features, e.g., to make conclusions based on data from data store 140 (e.g., defect classification from defect data of metrology data 160, defect image features from defect images captured by manufacturing equipment 124, etc.). In some embodiments, features which may be generated by one or more machine learning models, algorithms, statistical models, rule-based models, or the like may be provided to further machine learning models. For example, output of a number of trained machine learning models may be provided to a further machine learning model of models 190 to determine or predict defect root causes, provide a partition plan, provide defect analysis, etc.

In some embodiments, the various models discussed in connection with model 190 (e.g., supervised machine learning model, unsupervised machine learning model, etc.) may be combined in one model (e.g., an ensemble model), or may be separate models.

Data may be passed back and forth between several distinct models included in model 190 and predictive component 114. In some embodiments, some or all of these operations may instead be performed by a different device, e.g., client device 120, server machine 170, server machine 180, etc. It will be understood by one of ordinary skill in the art that variations in data flow, which components perform which processes, which models are provided with which data, and the like are within the scope of this disclosure.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers). The data store 140 may store manufacturing parameters 150, metrology data 160, hardware parameters 152, and predictive data 168.

Historical metrology data 166, historical hardware parameters 152, and historical manufacturing 150 parameters may be or include historical data (e.g., at least a portion of these data may be used for training model(s) 190). Current metrology data 166, current manufacturing parameters, and/or current hardware parameters may be current data (e.g., at least a portion to be input into learning model(s) 190, subsequent to the historical data) for which predictive data 168 is to be generated (e.g., for performing corrective actions).

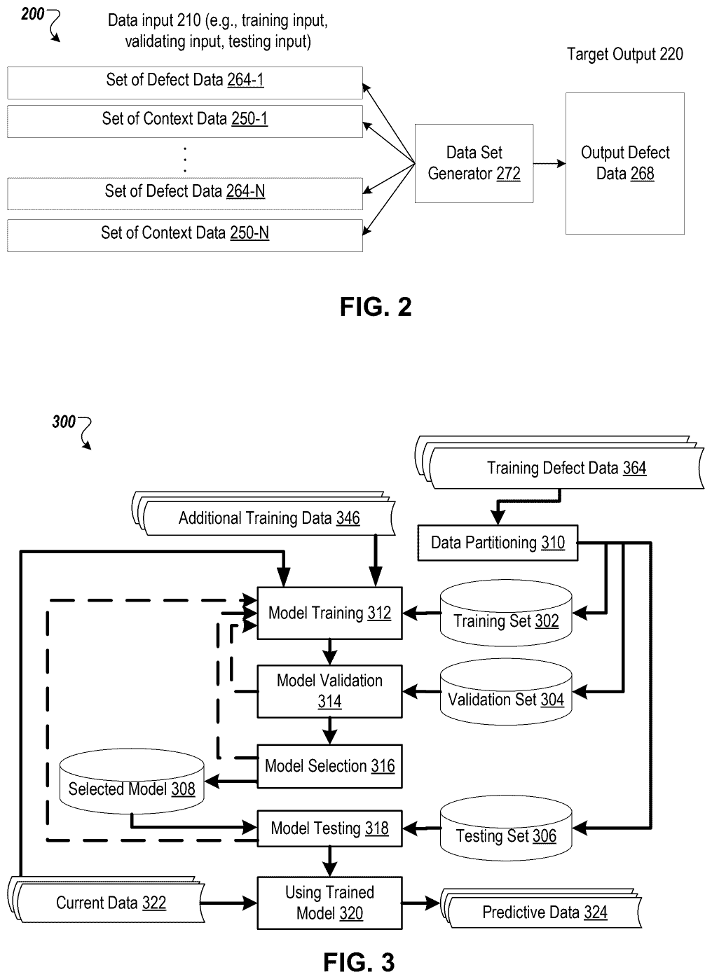

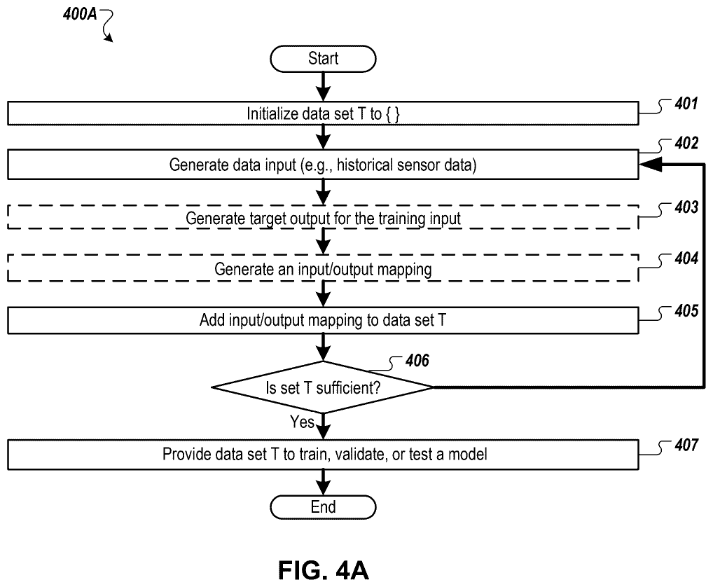

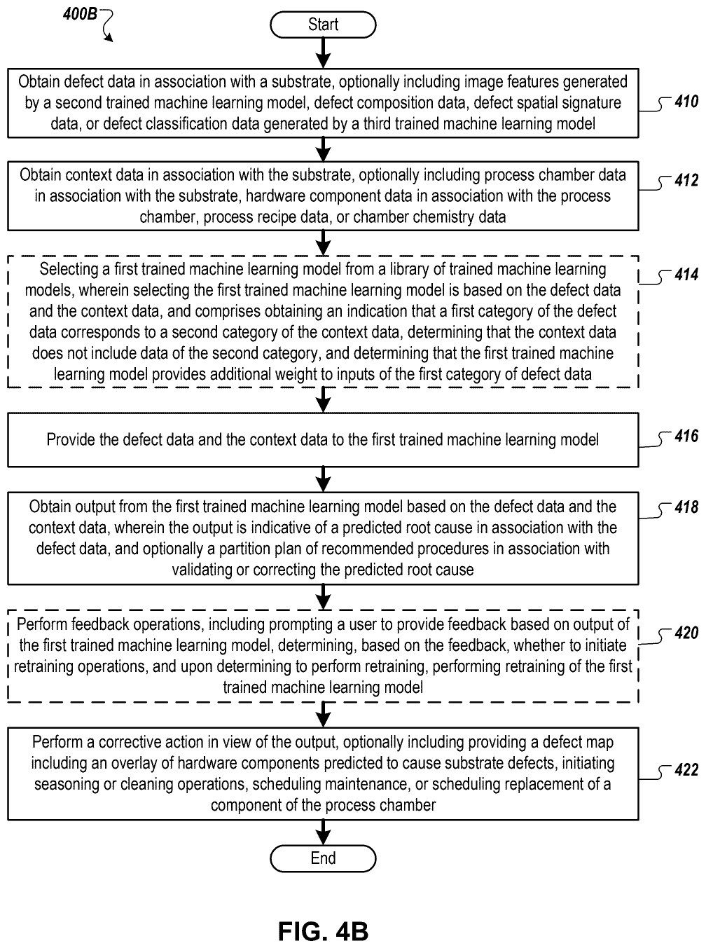

In some embodiments, predictive system 110 further includes server machine 170 and server machine 180. Server machine 170 includes a data set generator 172 that is capable of generating data sets (e.g., a set of data inputs and a set of target outputs) to train, validate, and/or test model(s) 190, including one or more machine learning models. Some operations of data set generator 172 are described in detail below with respect to FIGS. 2 and 4A. In some embodiments, data set generator 172 may partition the historical data (e.g., historical manufacturing parameters, historical metrology data 164) into a training set (e.g., sixty percent of the historical data), a validating set (e.g., twenty percent of the historical data), and a testing set (e.g., twenty percent of the historical data).

In some embodiments, predictive system 110 (e.g., via predictive component 114) generates multiple sets of features. For example a first set of features may correspond to a first set of types of metrology data (e.g., metrology data from a first set of metrology tools, features output by one or more analysis modules based on metrology data, patterns in metrology data or metrology data analytics, etc.) that correspond to each of the data sets (e.g., training set, validation set, and testing set) and a second set of features may correspond to a second set of types of metrology data that correspond to each of the data sets.

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a model 190 using one or more sets of features associated with the training set from data set generator 172. The training engine 182 may generate multiple trained models 190, where each trained model 190 corresponds to a distinct set of features of the training set (e.g., sensor data from a distinct set of sensors). For example, a first trained model may have been trained using all features (e.g., X1-X5), a second trained model may have been trained using a first subset of the features (e.g., X1, X2, X4), and a third trained model may have been trained using a second subset of the features (e.g., X1, X3, X4, and X5) that may partially overlap the first subset of features. Data set generator 172 may receive the output of a trained model (e.g., output of a model configured to classify or generate features based on metrology measurements), collect that data into training, validation, and testing data sets, and use the data sets to train a second model (e.g., a machine learning model configured to output predictive data, perform defect analysis, perform corrective actions, etc.).

Validation engine 184 may be capable of validating a trained model 190 using a corresponding set of features of the validation set from data set generator 172. For example, a first trained machine learning model 190 that was trained using a first set of features of the training set may be validated using the first set of features of the validation set. The validation engine 184 may determine an accuracy of each of the trained models 190 based on the corresponding sets of features of the validation set. Validation engine 184 may discard trained models 190 that have an accuracy that does not meet a threshold accuracy. In some embodiments, selection engine 185 may be capable of selecting one or more trained models 190 that have an accuracy that meets a threshold accuracy. In some embodiments, selection engine 185 may be capable of selecting the trained model 190 that has the highest accuracy of the trained models 190.

Testing engine 186 may be capable of testing a trained model 190 using a corresponding set of features of a testing set from data set generator 172. For example, a first trained machine learning model 190 that was trained using a first set of features of the training set may be tested using the first set of features of the testing set. Testing engine 186 may determine a trained model 190 that has the highest accuracy of all of the trained models based on the testing sets.

In the case of a machine learning model, model 190 may refer to the model artifact that is created by training engine 182 using a training set that includes data inputs and corresponding target outputs (correct answers for respective training inputs). In embodiments, the training set includes synthetic microscopy images generated by synthetic data generator 174. Patterns in the data sets can be found that map the data input to the target output (the correct answer), and machine learning model 190 is provided mappings that capture these patterns. The machine learning model 190 may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network), etc.

In some embodiments, one or more machine learning models 190 may be trained using historical data (e.g., historical metrology data 164). In some embodiments, models 190 may have been trained using output of other models, such as portions of metrology data 160 that are output by an analysis model based on measurements of metrology equipment 128.

Predictive component 114 may provide current data to model 190 and may run model 190 on the input to obtain one or more outputs. For example, predictive component 114 may provide manufacturing parameters, hardware parameters, and/or metrology data to model 190 and may run model 190 on the input to obtain one or more outputs. Predictive component 114 may be capable of determining (e.g., extracting) predictive data 168 from the output of model 190. Predictive component 114 may determine (e.g., extract) confidence data from the output that indicates a level of confidence that predictive data 168 is an accurate predictor of a process associated with the input data for products produced or to be produced using the manufacturing equipment 124. Predictive component 114 or corrective action component 122 may use the confidence data to decide whether to cause a corrective action associated with the manufacturing equipment 124 based on predictive data 168.

The confidence data may include or indicate a level of confidence that the predictive data 168 is an accurate prediction for products or components associated with at least a portion of the input data. In one example, the level of confidence is a real number between 0 and 1 inclusive, where 0 indicates no confidence that the predictive data 168 is an accurate prediction for products processed according to input data or component health of components of manufacturing equipment 124 and 1 indicates absolute confidence that the predictive data 168 accurately predicts properties of products processed according to input data or component health of components of manufacturing equipment 124. Responsive to the confidence data indicating a level of confidence below a threshold level for a predetermined number of instances (e.g., percentage of instances, frequency of instances, total number of instances, etc.) predictive component 114 may cause trained model 190 to be retrained. In some embodiments, user feedback (e.g., via client device 120) may cause one or more of the model(s) 190 to be retrained. In some embodiments, retraining may include generating one or more data sets (e.g., via data set generator 172) utilizing historical data.

For purpose of illustration, rather than limitation, aspects of the disclosure describe the training of one or more machine learning models 190 using historical data and inputting current into the one or more trained machine learning models to determine predictive data 168. In other embodiments, a heuristic model, physics-based model, or rule-based model is used to determine predictive data 168 (e.g., without using a trained machine learning model). In some embodiments, such models may be trained using historical data. In some embodiments, these models may be retrained utilizing historical data. Predictive component 114 may monitor historical data to determine changes to chamber condition, equipment condition, model accuracy, or the liek. Any of the information described with respect to data inputs 210 of FIG. 2 may be monitored or otherwise used in the heuristic, physics-based, or rule-based model.

In some embodiments, the functions of client device 120, predictive server 112, server machine 170, and server machine 180 may be provided by a fewer number of machines. For example, in some embodiments server machines 170 and 180 may be integrated into a single machine, while in some other embodiments, server machine 170, server machine 180, and predictive server 112 may be integrated into a single machine. In some embodiments, client device 120 and predictive server 112 may be integrated into a single machine. In some embodiments, functions of client device 120, predictive server 112, server machine 170, server machine 180, and data store 140 may be performed by a cloud-based service.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 may determine the corrective action based on the predictive data 168. In another example, client device 120 may determine the predictive data 168 based on output from the trained machine learning model.

In addition, the functions of a particular component can be performed by different or multiple components operating together. One or more of the predictive server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

FIG. 2 depicts a block diagram of example data set generator 272 (e.g., data set generator 172 of FIG. 1) to create data sets for training, testing, validating, etc. a model (e.g., model 190 of FIG. 1), according to some embodiments. Each data set generator 272 may be part of server machine 170 of FIG. 1. In some embodiments, several machine learning models associated with manufacturing equipment 124 may be trained, used, and maintained (e.g., within a manufacturing facility). Each machine learning model may be associated with one data set generators 272, multiple machine learning models may share a data set generator 272, etc.

FIG. 2 depicts a system 200 including data set generator 272 for creating data sets for one or more supervised models (e.g., model 190). Data set generator 272 may create data sets (e.g., data input 210, target output 220) using historical data. In some embodiments, a data set generator similar to data set generator 272 may be utilized to train an unsupervised machine learning model, e.g., target output 220 may not be generated by data set generator 272. For example, a machine learning model may be configured to perform clustering operations or outlier recognition, and such a model may be trained in an unsupervised manner.

Data set generator 272 may generate data sets to train, test, and validate a model. In some embodiments, data set generator 272 may generate data sets for a machine learning model. In some embodiments, data set generator 272 may generate data sets for training, testing, and/or validating a defect analysis model configured to predict defect root causes, and/or perform other operations associated with substrate defects. The machine learning model is provided with set of defect data 264-1 and/or set of context data 250-1 as data input 210. The defect data may include measurements of one or more substrate defects, such as defect images, features extracted from defect images, defect spectral data, composition extracted from spectral data, etc. The context data may include data related to generation of substrate defects, such as hardware data, hardware maintenance history data, process recipe data, chamber condition data, etc. The machine learning model may be configured to accept defect and context data as input data and generate predictive data for correcting defect root causes as output data.

Data set generator 272 may be used to generate data for any type of machine learning model that takes as input defect and/or context data. Data set generator 272 may be used to generate data for a machine learning model that generates predicted metrology data of a substrate. Data set generator 272 may be used to generate data for a machine learning model configured to provide process control instructions. Data set generator 272 may be used to generate data for a machine learning model configured to identify a product anomaly and/or processing equipment fault. Data set generator 272 may be used to generate data for a machine learning model configured to predict defect root causes, and/or generate a partition plan for addressing defect root causes.

In some embodiments, data set generator 272 generates a data set (e.g., training set, validating set, testing set) that includes one or more data inputs 210 (e.g., training input, validating input, testing input). Data inputs 210 may be provided to training engine 182, validating engine 184, or testing engine 186. The data set may be used to train, validate, or test the model (e.g., model 190 of FIG. 1).

In some embodiments, data input 210A may include one or more sets of data. As an example, system 20A may produce sets of defect data that may include one or more of defect data from one or more types of metrology tools, combinations of defect data from one or more types of metrology tools, patterns from defect data from one or more analysis or extracted features of metrology data, or the like.

In some embodiments, data input 210 may include one or more sets of data. As an example, system 200 may produce sets of historical defect data that may include one or more of metrology data of a group of dimensions of a device (e.g., include height and width of the device but not optical data or surface roughness, etc.), metrology data derived from one or more types of sensors, combination of metrology data derived from one or more types of sensors, patterns from metrology data, etc. Sets of data input 210 may include data describing different aspects of manufacturing, e.g., a combination of metrology data and sensor data, a combination of metrology data and manufacturing parameters, combinations of some metrology data, some manufacturing parameter data and some sensor data, etc.

In some embodiments, data set generator 272 may generate a first data input corresponding to a first set of defect data 264-1 to train, validate, or test a first machine learning model. Data set generator 272 may generate a second data input corresponding to a second set of historical defect data (e.g., a set of historical metrology data 264-2, not shown) to train, validate, or test a second machine learning model. Further sets of historical metrology data may further be utilized in generating further machine learning models. Any number of sets of historical defect data may be utilized in generating any number of machine learning models, up to a final set, set of historical defect data 264-N, N representing any target quantity of data sets, models, etc. Similarly, multiple sets (e.g., corresponding sets) of any other input data, including sets of context data 250-1, 250-2, . . . 205-N may be utilized in training a machine learning model.

In some embodiments, data set generator 272 generates a data set (e.g., training set, validating set, testing set) that includes one or more data inputs 210 (e.g., training input, validating input, testing input) and may include one or more target outputs 220 that correspond to the data inputs 210. The data set may also include mapping data that maps the data inputs 210 to the target outputs 220. In some embodiments, data set generator 272 may generate data for training a machine learning model configured to output predicted defect root causes, defect analysis, and or partition plans associated with correcting defect root causes, by outputting predictive defect data. For training such a model, data set generator 272 may generate target output data corresponding to the data input, e.g., output defect data 268. Data inputs 210 may also be referred to as “features,” “attributes,” or “information.” In some embodiments, data set generator 272 may provide the data set to training engine 182, validating engine 184, or testing engine 186, where the data set is used to train, validate, or test the machine learning model (e.g., one of the machine learning models that are included in model 190, ensemble model 190, etc.).

Data inputs 210 to train, validate, or test a machine learning model may include information for a particular manufacturing chamber (e.g., for particular substrate manufacturing equipment). In some embodiments, data inputs 210 may include information for a specific type of manufacturing equipment, e.g., manufacturing equipment sharing specific characteristics. Data inputs 210 may include data associated with a device of a certain type, e.g., intended function, design, produced with a particular recipe, etc. Data inputs 210 may be associated with a target collection of input data, e.g., weight may be applied to various portions of input data to account for data reliability, availability, completeness, or the like.

In some embodiments, subsequent to generating a data set and training, validating, or testing a machine learning model using the data set, the model may be further trained, validated, or tested, or adjusted (e.g., adjusting weights or parameters associated with input data of the model, such as connection weights in a neural network).

FIG. 3 is a block diagram illustrating system 300 for generating output data (e.g., predictive data 168 of FIG. 1), according to some embodiments. In some embodiments, system 300 may be used in conjunction with one or more machine learning models configured to generate predictive defect data, such as root cause data, partition plan data, analysis data, etc. In some embodiments, system 300 may be used in conjunction with a machine learning model to determine a corrective action associated with manufacturing equipment. In some embodiments, system 300 may be used in conjunction with a machine learning model to determine a fault of manufacturing equipment. In some embodiments, system 300 may be used in conjunction with a machine learning model to cluster or classify substrate defects. System 300 may be used in conjunction with a machine learning model with a different function than those listed, associated with a manufacturing system.

At block 310, system 300 (e.g., components of predictive system 110 of FIG. 1) performs data partitioning (e.g., via data set generator 172 of server machine 170 of FIG. 1) of data to be used in training, validating, and/or testing a machine learning model. In some embodiments, training defect data 364 includes historical data, such as historical metrology data, historical context data, historical classification data (e.g., classification of whether a product meets performance thresholds), historical microscopy image data, etc. Training data 364 may undergo data partitioning at block 310 to generate training set 302, validation set 304, and testing set 306. For example, the training set may be 60% of the training data, the validation set may be 20% of the training data, and the testing set may be 20% of the training defect data 364.

The generation of training set 302, validation set 304, and testing set 306 may be tailored for a particular application. For example, the training set may be 60% of the training data, the validation set may be 20% of the training data, and the testing set may be 20% of the training data. System 300 may generate a plurality of sets of features for each of the training set, the validation set, and the testing set. For example, if training defect data 364 includes features extracted from metrology data, including 20 image features, and 10 manufacturing parameters (e.g., manufacturing parameters that correspond to the same processing runs(s) as the substrates depicted in the image data), the image feature data may be divided into a first set of features including image features 1-10 and a second set of features including image features 11-20. The manufacturing parameters may also be divided into sets, for instance a first set of manufacturing parameters including parameters 1-5, and a second set of manufacturing parameters including parameters 6-10. Either target input, target output, both, or neither may be divided into sets. Multiple models may be trained on different sets of data.

At block 312, system 300 performs model training (e.g., via training engine 182 of FIG. 1) using training set 302. Training of a machine learning model and/or of a physics-based model (e.g., a digital twin) may be achieved in a supervised learning manner, which involves providing a training dataset including labeled inputs through the model, observing its outputs, defining an error (by measuring the difference between the outputs and the label values), and using techniques such as deep gradient descent and backpropagation to tune the weights of the model such that the error is minimized. In many applications, repeating this process across the many labeled inputs in the training dataset yields a model that can produce correct output when presented with inputs that are different than the ones present in the training dataset. In some embodiments, training of a machine learning model may be achieved in an unsupervised manner, e.g., labels or classifications may not be supplied during training. An unsupervised model may be configured to perform anomaly detection, result clustering, etc.

For each training data item in the training dataset, the training data item may be input into the model (e.g., into the machine learning model). The model may then process the input training data item (e.g., a number of measured dimensions of a manufactured device, a cartoon picture of a manufactured device, etc.) to generate an output. The output may include, for example, a predicted defect root cause. The output may be compared to a label of the training data item (e.g., a root cause labeled by a subject matter expert in association with defects of the historical training data).

Processing logic may then compare the generated output (e.g., predicted defect root cause) to the label (e.g., provided root cause in association with the input data) that was included in the training data item. Processing logic determines an error (i.e., a classification error) based on the differences between the output and the label(s). Processing logic adjusts one or more weights and/or values of the model based on the error.

In the case of training a neural network, an error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

System 300 may train multiple models using multiple sets of features of the training set 302 (e.g., a first set of features of the training set 302, a second set of features of the training set 302, etc.). For example, system 300 may train a model to generate a first trained model using the first set of features in the training set (e.g., image feature data from image features 1-10, metrology measurements 1-10, etc.) and to generate a second trained model using the second set of features in the training set (e.g., image feature data from image features 11-20, metrology measurements 11-20, etc.). In some embodiments, the first trained model and the second trained model may be combined to generate a third trained model (e.g., which may be a better predictor or synthetic data generator than the first or the second trained model on its own). In some embodiments, sets of features used in comparing models may overlap (e.g., first set of features being image feature data from image features 1-15 and second set of features being image feature data from image features 5-20). In some embodiments, hundreds of models may be generated including models with various permutations of features and combinations of models.

At block 314, system 300 performs model validation (e.g., via validation engine 184 of FIG. 1) using the validation set 304. The system 300 may validate each of the trained models using a corresponding set of features of the validation set 304. For example, system 300 may validate the first trained model using the first set of features in the validation set (e.g., image feature data from image features 1-10 or metrology measurements 1-10) and the second trained model using the second set of features in the validation set (e.g., image feature data from image features 11-20 or metrology measurements 11-20). In some embodiments, system 300 may validate hundreds of models (e.g., models with various permutations of features, combinations of models, etc.) generated at block 312. At block 314, system 300 may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. System 300 may discard the trained models that have an accuracy that is below the threshold accuracy (e.g., based on the validation set).

At block 316, system 300 performs model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow may return to block 312 where the system 300 performs model training using further refined training sets corresponding to further refined sets of features for determining a trained model that has the highest accuracy.

At block 318, system 300 performs model testing (e.g., via testing engine 186 of FIG. 1) using testing set 306 to test selected model 308. System 300 may test, using the first set of features in the testing set (e.g., image feature data from image features 1-10), the first trained model to determine the first trained model meets a threshold accuracy. Determining whether the first trained model meets a threshold accuracy may be based on the first set of features of testing set 306. Responsive to accuracy of the selected model 308 not meeting the threshold accuracy, flow continues to block 312 where system 300 performs model training (e.g., retraining) using different training sets corresponding to different sets of features. Accuracy of selected model 308 may not meet threshold accuracy if selected model 308 is overly fit to the training set 302 and/or validation set 304. Accuracy of selected model 308 may not meet threshold accuracy if selected model 308 is not applicable to other data sets, including testing set 306. Training using different features may include training using data from different sensors, different manufacturing parameters, etc. Responsive to determining that selected model 308 has an accuracy that meets a threshold accuracy based on testing set 306, flow continues to block 320. In at least block 312, the model may learn patterns in the training data to make predictions. In block 318, the system 300 may apply the model on the remaining data (e.g., testing set 306) to test the predictions.

At block 320, system 300 uses the trained model (e.g., selected model 308) to receive current data 322 and determines (e.g., extracts), from the output of the trained model, predictive data 324. Current data 322 may be manufacturing parameters related to a process, operation, or action of interest. Current data 322 may be manufacturing parameters related to a process under development, redevelopment, investigation, etc. Current data 322 may be metrology data indicative of defects of a substrate of interest. Current data 322 may be manufacturing parameters or hardware parameters (e.g., context data) in association with one or more substrate defects of interest. A corrective action associated with the manufacturing equipment 124 of FIG. 1 may be performed in view of predictive data 324. In some embodiments, current data 322 may correspond to the same types of features in the historical data used to train the machine learning model. In some embodiments, current data 322 corresponds to a subset of the types of features in historical data that are used to train selected model 308. For example, a machine learning model may be trained using a number of manufacturing parameters, and configured to generate output based on a subset of the manufacturing parameters.

In some embodiments, the performance of a machine learning model trained, validated, and tested by system 300 may deteriorate. For example, a manufacturing system associated with the trained machine learning model may undergo a gradual change or a sudden change. A change in the manufacturing system may result in decreased performance of the trained machine learning model. A new model may be generated to replace the machine learning model with decreased performance. The new model may be generated by altering the old model by retraining, by generating a new model, etc.

Generation of a new model may include providing additional training data 346. Generation of a new model may further include providing current data 322, e.g., data that has been used by the model to make predictions. In some embodiments, current data 322 when provided for generation of a new model may be labeled with an indication of an accuracy of predictions generated by the model based on current data 322. Additional training data 346 may be provided to model training 312 for generation of one or more new machine learning models, updating, retraining, and/or refining of selected model 308, etc.

In some embodiments, one or more of the acts 310-320 may occur in various orders and/or with other acts not presented and described herein. In some embodiments, one or more of acts 310-320 may not be performed. For example, in some embodiments, one or more of data partitioning of block 310, model validation of block 314, model selection of block 316, or model testing of block 318 may not be performed.

FIG. 3 depicts a system configured for training, validating, testing, and using one or more machine learning models. The machine learning models are configured to accept data as input (e.g., set points provided to manufacturing equipment, hardware configuration data, metrology data, etc.) and provide data as output (e.g., predictive data, corrective action data, classification data, etc.). Partitioning, training, validating, selection, testing, and using blocks of system 300 may be executed similarly to train a second model, utilizing different types of data. Retraining may also be performed, utilizing current data 322 and/or additional training data 346.

FIGS. 4A-B are flow diagrams of methods 400A-B associated with training and utilizing machine learning models, according to certain embodiments. Methods 400A-B may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-B may be performed, in part, by predictive system 110. Method 400A may be performed, in part, by predictive system 110 (e.g., server machine 170 and data set generator 172 of FIG. 1, data set generator 272 of FIG. 2). Predictive system 110 may use method 400A to generate a data set to at least one of train, validate, or test a machine learning model, in accordance with embodiments of the disclosure. Method 400B may be performed by predictive server 112 (e.g., predictive component 114), client device 120, and/or server machine 180 (e.g., training, validating, and testing operations may be performed by server machine 180). In some embodiments, a non-transitory machine-readable storage medium stores instructions that when executed by a processing device (e.g., of predictive system 110, of server machine 180, of predictive server 112, etc.) cause the processing device to perform one or more of methods 400A-B.

For simplicity of explanation, methods 400A-B are depicted and described as a series of operations. However, operations in accordance with this disclosure can occur in various orders and/or concurrently and with other operations not presented and described herein. Furthermore, not all illustrated operations may be performed to implement methods 400A-B in accordance with the disclosed subject matter. In addition, those skilled in the art will understand and appreciate that methods 400A-B could alternatively be represented as a series of interrelated states via a state diagram or events.

FIG. 4A is a flow diagram of a method 400A for generating a data set for a machine learning model, according to some embodiments. Referring to FIG. 4A, in some embodiments, at block 401 the processing logic implementing method 400A initializes a training set T to an empty set.

At block 402, processing logic generates first data input (e.g., first training input, first validating input) that may include one or more of hardware parameters, manufacturing parameters, metrology data, context data, defect data, etc. In some embodiments, the first data input may include a first set of features for types of data and a second data input may include a second set of features for types of data (e.g., as described with respect to FIG. 3). Input data may include historical data in some embodiments.

In some embodiments, at block 403, processing logic optionally generates a first target output for one or more of the data inputs (e.g., first data input). In some embodiments, the input includes one or more instances of defect and context data and the target output is a root cause of one or more defects. In some embodiments, the input includes data indicative of substrate defects and the target output is a root cause correction and/or validation partition plan. In some embodiments, the first target output is predictive data. In some embodiments, no target output is generated (e.g., an unsupervised machine learning model capable of grouping or finding correlations in input data, rather than requiring target output to be provided). An example of unsupervised training may include a machine learning model configured to determine clustering or grouping of substrate defects predicted to be related to the same root cause.

At block 404, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, such as in association with machine learning models where no target output is provided, block 404 may not be executed.

At block 405, processing logic adds the mapping data generated at block 404 to data set T, in some embodiments.

At block 406, processing logic branches based on whether data set T is sufficient for at least one of training, validating, and/or testing a machine learning model, such as model 190 of FIG. 1. If so, execution proceeds to block 407, otherwise, execution continues back at block 402. It should be noted that in some embodiments, the sufficiency of data set T may be determined based simply on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 407, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 407, a model (e.g., model 190) can be at least one of trained using training engine 182 of server machine 180, validated using validating engine 184 of server machine 180, or tested using testing engine 186 of server machine 180. The trained model may be implemented by predictive component 114 (of predictive server 112) to generate predictive data 168 for performing signal processing, or for performing a corrective action associated with manufacturing equipment 124.

FIG. 4B is a flow diagram of a method 400B for generating and utilizing predicted defect root cause data, according to some embodiments. At block 410 of method 400B, processing logic obtains defect data in association with a substrate. The defect data may include image features. The image features may be or include features of a defect image. The image feature may be generated by a trained machine learning model. The defect data may include spectral data. The defect data may include defect composition data, which may be based on spectral data. The composition data may be generated by a physics-based model, a machine learning model, a physics-based model with output modified based on context data (e.g., process recipe data may be used to exclude one or more components determined based on spectral data, which are unlikely to be included in the defect). The defect data may include defect spatial signature data. The defect spatial signature data may include a classification of a pattern of locations of related defects, e.g., of one substrate, related defects across multiple substrates, etc. In some embodiments, defect spatial signature data may be determined by a trained machine learning model. Defect data may include defect classification data. Defect classification data may be generated by a trained machine learning model.

At block 412, process logic obtains context data in association with the substrate. The context data may include process chamber data in association with the substrate. The context data may include hardware component data in association with the process chamber. The context data may include process recipe data in association with the substrate. The context data may include chamber chemistry data and/or process chemistry data in association with the substrate.

At block 414, process logic optionally selects a first trained machine learning model from a library of trained machine learning models. Selecting the first trained machine learning model may be based on the defect data and the context data. Selecting the first trained machine learning model may include obtaining an indication that a first category of the defect data corresponds toa second category of the context data. For example, defect composition may be highly correlated to process chemistry data, and these two types of data may be linked as corresponding data. Selecting the first trained machine learning model may further include determining that one of the corresponding data types is missing, incomplete, unreliable, or the like. Selecting the first trained machine learning model may include selecting a model that provides weightings to input data to account for the missing, incomplete, or unreliable data. For example, context data of a corresponding type of defect data may be missing, incomplete, or unreliable, and a model may be selected that provides additional weight to the corresponding data types, to correct operations of the model such that results that normally depend in part on the missing or incomplete data may still be achieved. For example, selecting the first trained machine learning model may include determining that the context data does not include data of the second category, and determining that the first trained machine learning model provides additional weight to inputs of the first category of defect data.

At block 416, process logic provides the defect data and the context data to the first trained machine learning model. The defect data and the context data may be provided as input. In some embodiments, additional inputs may be provided. For example, instead or in addition to selection of the first trained machine learning model from a library of models, a model may be provided an input that causes the model to operate differently to account for missing, unreliable, or incomplete data, e.g., a model for defect root cause analysis may be a universal model.

At block 418, process logic obtains output from the first trained machine learning model. The output may be based on the defect data and the context data. The output is indicative of one or more predicted root causes in association with the defect data. The output may include a partition plan of recommended procedures in association with validating and/or correcting the predicted one or more root causes.

At block 420, process logic optionally performs feedback operations. The feedback operations may be directed at receiving input from one or more users or subject matter experts to improve operations of a defect root cause analysis system, model, or the like. Feedback operations may include prompting a user (e.g., via a user interface, such as a GUI of client device 120 of FIG. 1) to provide feedback based on output of the first trained machine learning model. Feedback operations may include obtaining user feedback. Feedback operations may include determining, based on feedback provided by the user, whether to initiate retraining operations. Feedback operations may include performing retraining of the first trained machine learning model.

At block 422, process logic performs a corrective action in view of the output. The corrective action may include providing a defect map to a user. The defect map may include an overlay of hardware components predicted to cause substrate defects. The corrective action may include initiating seasoning or cleaning operations. The corrective action may include scheduling maintenance of the process chamber. The corrective action may include scheduling replacement of a component of the process chamber.

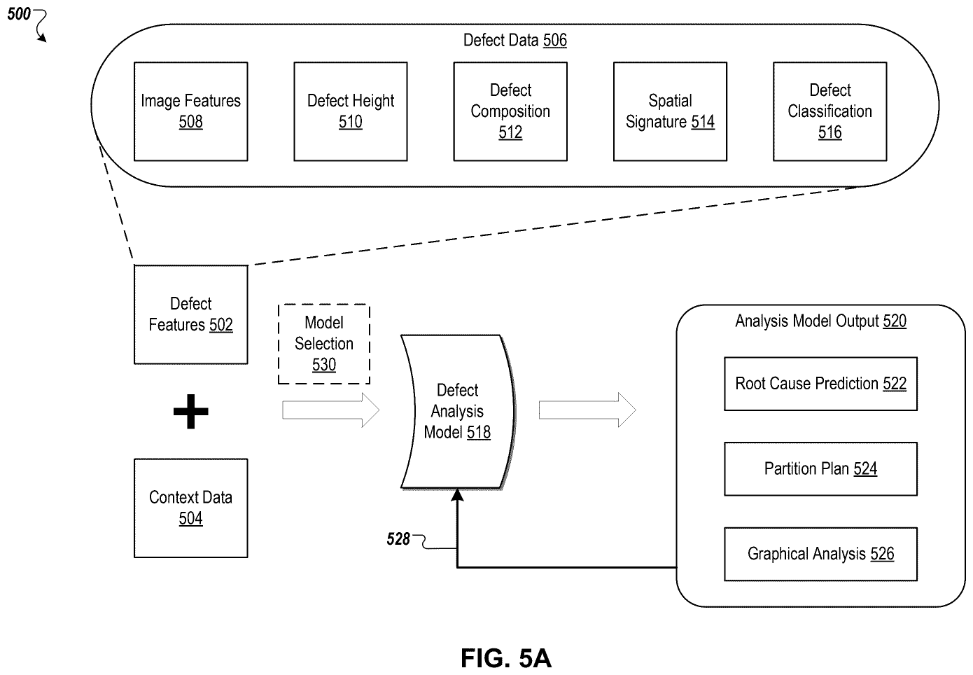

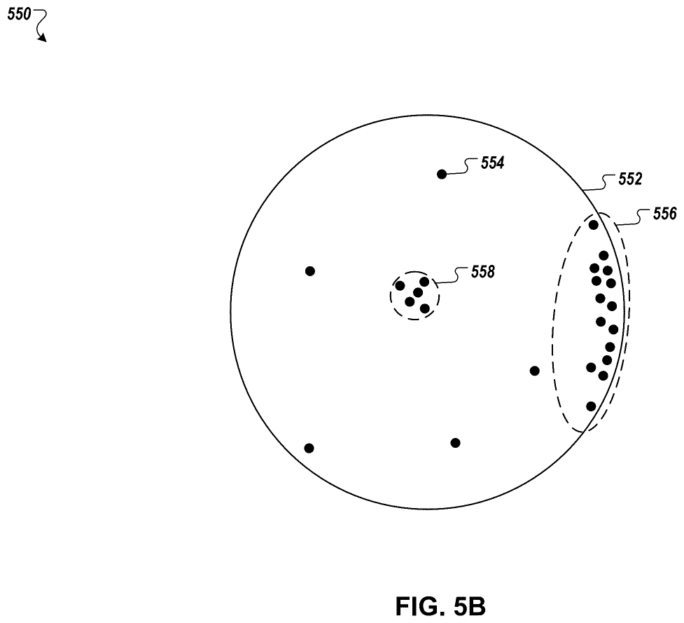

FIG. 5A depicts a data flow 500 in association with operation of a defect analysis system, according to some embodiments. Data flow 500 includes providing input data to defect analysis model 518 to obtain as output analysis model output 520. The input data provided to defect analysis model 518 includes defect features 502 and context data 504. Defect features 502 may include a number of various types of defect data 506, which may include one or more of image features 508, defect height 510, defect composition 512, spatial signature 514, defect classification 516, or other defect data that may be of interest in executing operations of the defect analysis system. Output of the analysis model may include predictions 522, partition plan 524, and graphical analysis 526. Expert input, data-driven feedback, or the like may be integrated into feedback loop 528, e.g., for retraining of defect analysis model 518, for improvement of the defect analysis system, etc. Model selection 530 of defect analysis model 518 from a library of models may optionally be performed before providing data to defect analysis model 518

Defect data 506 may be generated based on measurements performed by metrology equipment (e.g., metrology equipment 128 of FIG. 1). Data generated during one or more measurements of a defect, a substrate including a defect, one or more substrates including defects, etc., may be provided to one or more analysis models for generating defect data 506. Each data type included in defect data 206 may be provided based on analysis of metrology data associated with one or more types of defect data. For example, multiple categories of defect data 506 may be associated with the same set of metrology data, such as image features 508 and defect height 510 both being based on defect image data generated by a substrate imaging metrology device.

Defect data 506 may be generated by providing metrology or measurement data to analysis modules. These analysis modules may be preexisting modules, e.g., an algorithm for determining defect composition may provide output associated with data included in defect composition 512. The analysis modules may be or include trained machine learning models. In some embodiments, additional processing may be performed before providing the data as defect features 502. For example, some features that are of less importance in root cause predictions may be excluded from defect features 502.

Image features 508 may be generated by one or more analysis modules from defect image data. Image features 508 may be generated by one or more trained machine learning models. Image features 508 may be generated by one or more computer vision models. Image features 508 may be extracted from images with high variability in quality, source tool, resolution, clarity, brightness, etc. In some embodiments, image data may be pre-processed, e.g., to remove text or artifacts, to improve image quality (e.g., by Fourier filtering), to adjust brightness or contrast, etc. In some embodiments, a large number of features may be extracted from image data. A subset of image features may be provided as defect features 502. For example, some features may be selected as particularly relevant to root cause prediction by a subject matter expert, some features may be selected as particularly valuable based on performing root cause prediction modeling and determining which image features have the greatest effect on modeling outcomes, etc. In some embodiments, some features may be extracted from an approximate image, e.g., a trained machine learning model may be configured to estimate defect features based on a sketch made by a user who had observed a defect, without actual image data.

Defect height 510 may be generated by one or more analysis modules from data of a substrate defect. Data height 510 may be generated algorithmically. Data height 510 may be generated based on image data, e.g., images of a defect of a substrate taken from multiple angles may be utilized in determining defect height.

Defect composition 512 may be generated by analysis modules including physics-based models, machine learning models, rule-based models, etc. In some embodiments, a physics simulation model may be utilized to extract atomic composition of defects based on spectral data. In some cases, additional analysis may be performed on top of a physics simulation model, such as to exclude erroneous signals, artifacts, materials that are not likely to be included in a particular manufacturing process, or the like.

Spatial signature 514 may include a classification of a spatial distribution of defects across substrate surfaces. For example, defects may occur most commonly near the center of a substrate, near an edge of the substrate, in a star-shaped pattern, in a crescent pattern, or another pattern of defect distribution. A particular pattern, location, location density, or the like of defects may be indicative of defect root causes. Spatial signature 514 may be determined by one or more trained machine learning models. Defect classification (e.g., particle, pit, scratch, etc.) may similarly be based on output of trained machine learning models, configured to classify defects based on metrology data.

Context data 504 may include data related to defect generation, a process environment contributing to defect generation, etc. Context data 504 may include information related to conditions or processes that may contribute to defect formation, different than data generated by measuring or imaging one or more defects. Context data may include data identifying manufacturing equipment in association with one or more substrate defects. Context data may include identifications of a manufacturing facility, process tool, process chamber, or the like involved in processing one or more substrates including defects of interest. Identifications of manufacturing equipment may include indications of equipment type or model, equipment history, equipment performance, etc. In some embodiments, based on identification data, defect analysis model 518 may predict manufacturing equipment performance without specifically being provided with equipment performance data, e.g., based on trends in training data including performance of the equipment. Context data may include identification of components included in manufacturing equipment. In some embodiments, the context data may include information about included components, such as component type, model, age, historical performance, etc. Component performance may be inferred by defect analysis model 518 based on training data, e.g., similar to equipment performance.

Context data 504 may include data related to conditions generated by materials introduced to the process chamber. Context data 504 may include process data, e.g., data indicative of a process recipe or one or more processes performed by the process chamber in association with substrates including defects of interest. The process data may include data related to process gases provided to the chamber, temperature data, plasma data, pumping conditions, or other process data that may contribute to defect generation. Context data 504 may include seasoning data, e.g., data associated with process chamber seasoning, coatings of components of the process chamber, cleaning operations performed in the process chamber, or the like. Context data 504 may include chemistry data, e.g., predicted chemistries, materials, or reactions that may cause defect generation, such as plasma, etch, or deposition byproducts, interactions of substrate, chamber, coating, or seasoning materials with process gases, plasma byproducts, or the like.

An optional operation of model selection 530 may be performed. Model selection 530 may be performed based on input data, e.g., based on defect features 502 and/or context data 504. Model selection 530 may be used to correct for differences in data provided for analysis, such as by providing a variety of choices of weightings, process parameters, or other differences that may cause improved predictive results when a model is selected from a library of models. In some embodiments, model selection 530 may be bypassed, e.g., a universal model may be utilized with one or more inputs to the model used to adjust operation of the model, e.g., performance of multiple models selected between in model selection 530 may be included in a single universal model with one or more inputs indicative of differences that may be used in selecting a model in model selection 530.

In some embodiments, missing, unreliable, or inconsistent data in one area may be augmented with corresponding data in another area. For example, it may be determined that some types of data are correlated. For example, defect classification may be correlated with spatial signature. Correlations may be provided by subject matter experts, extracted from data, extracted from model parameters, or the like. When data of one set of correlated data types is missing, incomplete, or unreliable, a machine learning model may be selected, or inputs to a universal model provided, that provides additional weight to other correlated data types. In some embodiments, missing, incomplete, or unreliable context data may be augmented by providing additional weight to corresponding defect data. In some embodiments, missing, incomplete, or unreliable defect data may be augmented by providing additional weight to corresponding context data. For example, process, seasoning, or chemistry data may be correlated with defect composition data, while hardware component data may be correlated with spatial signature data. Additional weight may be provided to increase accuracy of root cause determination operations in the corresponding categories.

Various defect features 502 extracted from defect data 506 may be combined with context data 504 and provided to defect analysis model 518, which may be a trained machine learning model. Defect analysis model 518 may be trained based on a large volume of training data. Defect analysis model 518 may be configured to generate predictive information in association with one or more substrate defects. Defect analysis model 518 may be configured to generate analysis model output 520.

Analysis model output 520, based on defect features 502 and context data 504, may include root cause prediction 522. Root cause prediction 522 includes one or more predicted root causes of defects in association with manufacturing equipment. Root cause prediction 522 may include one or more indications of confidence associated with the root cause predictions. Analysis model output 520 may include partition plan 524. A partition plan may include predictions, instructions, and/or recommendations for proceeding to address predicted root causes. Partition plan 524 may include a series of operations that may assist a technician or engineer in tracking and/or correcting defect root causes. Partition plan 524 may provide a plan based on predicted root causes, confidence values, impact of corrective actions (e.g., difficult maintenance with long chamber down times may be suggested later in a partition plan than simple operations), etc. Analysis model output 520 may include graphical analysis 526. Examples of graphical analysis may include charts, heat maps, graphs, or the like depicting data associated with predicted defect generation mechanisms. In some embodiments, graphical analysis 526 may include a map of a substrate, including one or more indications of spatial regions of a substrate that may be associated with target root causes, indications of specific defects of a substrate that are predicted to be associated with particular root causes, a map or overlay indicating hardware components likely to contribute to defects of a substrate (e.g., a defect map), or the like. In some embodiments, graphical analysis may include the use of further machine learning models. For example, data output of defect analysis model 518 may include clustering operations to group defects based on one or more defect parameters, and graphical analysis output may include indications of common root causes based on grouping or clustering of defects.

Feedback loop 528 may be utilized in updating one or more parameters of defect analysis model 518. For example, feedback loop 528 may enable technician, engineer, and/or subject matter expert feedback to improve predictions of defect analysis model 518, improve partition plans or graphics generated based on output of defect analysis model 518, or the like. Feedback loop 528 may include user input that may be utilized to retrain defect analysis model 518, retrain one or more models included in a library of models associated with model selection 530, or the like.

FIG. 5B depicts an example graphical defect analysis wafer signature output 550, according to some embodiments. The graphical output includes representations of various components in association with defect analysis procedures. Substrate 552 is depicted, including a number of indicators of defect locations, such as defect 554. The depicted defects may be all defects of a substrate, a collection of defects of a particular type, a collection of defects in association with a number of substrates manufactured by the same equipment, or the like.

The graphical output may include various groups of defects, such as group 556 and group 558. Groups may be designated by encircling a set of defect indicators, as shown, coloring of substrate or defect indicators, patterns of substrate or defect indicators, or another manner. Groups of defects may be generated based on clustering operations in association with defect data, such as clustering operations performed by a trained machine learning model. Grouping may be related to predicted root causes, to predicted hardware components contributing to the defects, or the like. For example, group 556 may include defects predicted to be associated with a first malfunctioning hardware components, while group 558 may include defects predicted to be associated with a second hardware component. In some embodiments, different hardware components may be likely to contribute to defects in different areas of a substrate (e.g., group 556 includes defects in and edge-proximate arc, group 558 includes defects near the substrate center, etc.). Providing an indication may enable a user, technician, or the like to determine whether to perform maintenance associated with correcting one or more groups of defects. The graphical output may further include one or more defect indications, such as defect indicator 554, that are not associated with a group, a particular root cause, a particular hardware component, or the like.

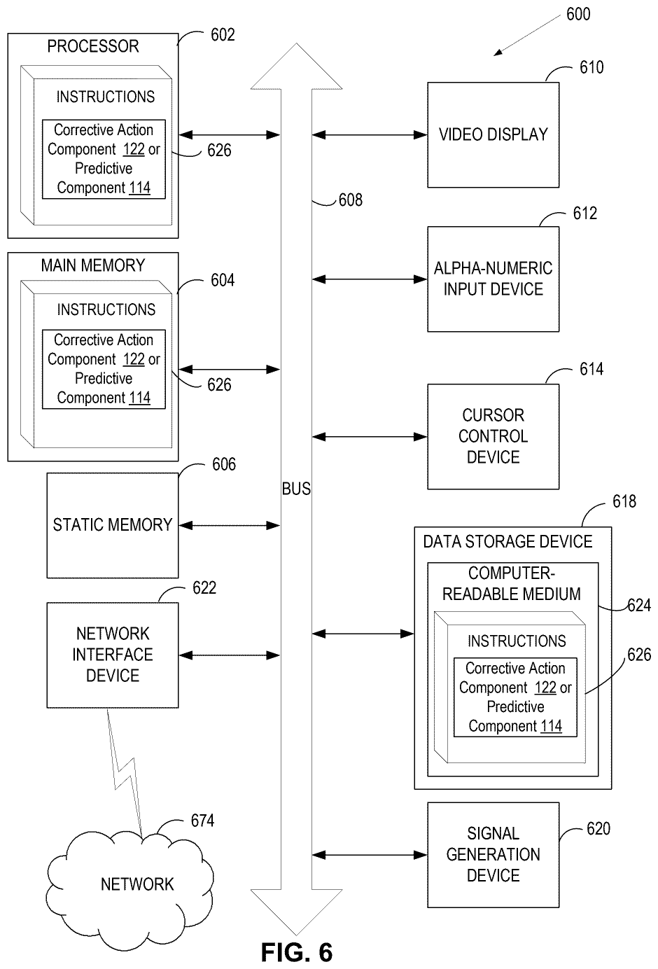

FIG. 6 is a block diagram illustrating a computer system 600, according to some embodiments. In some embodiments, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which may communicate with each other via a bus 608.

Processing device 602 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 may further include a network interface device 622 (e.g., coupled to network 674). Computer system 600 also may include a video display unit 610 (e.g., an LCD), an alphanumeric input device 612 (e.g., a keyboard), a cursor control device 614 (e.g., a mouse), and a signal generation device 620.

In some embodiments, data storage device 618 may include a non-transitory computer-readable storage medium 624 (e.g., non-transitory machine-readable medium, non-transitory machine-readable storage medium, or the like) on which may store instructions 626 encoding any one or more of the methods or functions described herein, including instructions encoding components of FIG. 1 (e.g., predictive component 114, corrective action component 122, model 190, etc.) and for implementing methods described herein.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

What is claimed is:

1. A method, comprising:
obtaining, by a processing device, defect data in association with a substrate;
obtaining, by the processing device, context data in association with the substrate;
providing the defect data and the context data to a first trained machine learning model as model input;
obtaining output from the first trained machine learning model based on the defect data and the context data, wherein the output is indicative of a predicted root cause in association with the defect data; and
performing a corrective action in view of the output.

2. The method of claim 1, wherein the defect data comprises one or more of:
image features generated by a second trained machine learning model;
defect composition data;
defect spatial signature data; or
defect classification data generated by a third trained machine learning model.

3. The method of claim 1, wherein the context data comprises one or more of:
process chamber data in association with the substrate;
hardware component data in association with the process chamber;
process recipe data; or
chamber chemistry data.

4. The method of claim 1, further comprising selecting, by the processing device, the first trained machine learning model from a library of trained machine learning models, wherein selecting the first trained machine learning model is based on the defect data and the context data.

5. The method of claim 4, wherein selecting the first trained machine learning model comprises:
obtaining an indication that a first category of the defect data corresponds to a second category of the context data;
determining that the context data does not include data of the second category; and
determining that the first trained machine learning model provides additional weight compared to a fourth trained machine learning model of the library of trained machine learning models to inputs of the first category of defect data.

6. The method of claim 1, wherein the corrective action comprises one or more of:
initiating seasoning operations of a process chamber;
initiating cleaning operations of the process chamber;
scheduling replacement of a component of the process chamber; or
scheduling maintenance of the process chamber.

7. The method of claim 1, wherein the output further comprises a partition plan, wherein the partition plan comprises a recommended procedure for validating the predicted root cause.

8. The method of claim 1, further comprising:
prompting a user to provide feedback based on output of the first trained machine learning model;
determining, based on the feedback, whether to initiate retraining operations; and
performing retraining of the first trained machine learning model.

9. The method of claim 1, further comprising providing a defect map to a user, wherein the defect map further comprises an overlay of hardware components predicted to contribute to defects of the defect map.

10. A non-transitory machine-readable storage medium storing instructions which, when executed, cause a processing device to perform operations comprising:
obtaining defect data in association with a substrate;
obtaining context data in association with the substrate;
providing the defect data and the context data to a first trained machine learning model;
obtaining output from the first trained machine learning model based on the defect data and the context data, wherein the output is indicative of a predicted root cause in association with the defect data; and
performing a corrective action in view of the output.

11. The non-transitory machine-readable storage medium of claim 10, wherein the defect data comprises one or more of:
image features generated by a second trained machine learning model;
defect composition data;
defect spatial signature data; or
defect classification data generated by a third trained machine learning model.

12. The non-transitory machine-readable storage medium of claim 10, wherein the context data comprises one or more of:
process chamber data in association with the substrate;
hardware component data in association with the process chamber;
process recipe data; or
chamber chemistry data.

13. The non-transitory machine-readable storage medium of claim 10, wherein the operations further comprise selecting the first trained machine learning model from a library of trained machine learning models, wherein selecting the first trained machine learning model comprises:
obtaining an indication that a first category of the defect data corresponds to a second category of the context data;
determining that the context data does not include data of the second category; and
determining that the first trained machine learning model provides additional weight compared to a fourth trained machine learning model of the library of trained machine learning models to inputs of the first category of defect data.

14. The non-transitory machine-readable storage medium of claim 10, wherein the corrective action comprises one or more of:
initiating seasoning operations of a process chamber;
initiating cleaning operations of the process chamber;
scheduling replacement of a component of the process chamber; or
scheduling maintenance of the process chamber.

15. The non-transitory machine-readable storage medium of claim 10, wherein the output further comprises a partition plan, wherein the partition plan comprises a recommended procedure for validating the predicted root cause.

16. A system, comprising memory and a processing device coupled to the memory, wherein the processing device is configured to:
obtain defect data in association with a substrate;
obtain context data in association with the substrate;
provide the defect data and the context data to a first trained machine learning model;
obtain output from the first trained machine learning model based on the defect data and the context data, wherein the output is indicative of a predicted root cause in association with the defect data; and
perform a corrective action in view of the output.

17. The system of claim 16, wherein the defect data comprises one or more of:
image features generated by a second trained machine learning model;
defect composition data;
defect spatial signature data; or
defect classification data generated by a third trained machine learning model.

18. The system of claim 16, wherein the context data comprises one or more of:
process chamber data in association with the substrate;
hardware component data in association with the process chamber;
process recipe data; or
chamber chemistry data.

19. The system of claim 16, wherein the processing device is further configured to select the first trained machine learning model from a library of trained machine learning models, wherein selecting the first trained machine learning model comprises:
obtaining an indication that a first category of the defect data corresponds to a second category of the context data;
determining that the context data does not include data of the second category; and
determining that the first trained machine learning model provides additional weight compared to a fourth trained machine learning model of the library of trained machine learning models to inputs of the first category of defect data.

20. The system of claim 16, wherein the corrective action comprises one or more of:
initiating seasoning operations of a process chamber;
initiating cleaning operations of the process chamber;
scheduling replacement of a component of the process chamber; or
scheduling maintenance of the process chamber.

21. The system of claim 16, further comprising:
providing a plurality of defect data in association with a plurality of substrates as training input data;
providing a plurality of context data in association with the plurality of substrates as training input data;
providing a plurality of root cause data in association with the plurality of substrates as target output data; and
training the first trained machine learning model based on the plurality of defect data, the plurality of context data, and the plurality of root cause data.
